(19) United States
(12) Patent Application Publication
(10) Pub. No.: US 2025/0260487 A1
(43) Pub. Date: Aug. 14, 2025

(54) GOSNR MEASUREMENT DEVICE AND GOSNR MEASUREMENT METHOD

(71) Applicant: ANRITSU CORPORATION, Kanagawa (JP)

(72) Inventors: Yosho KANDA, Kanagawa (JP); Shinji MORIMOTO, Kanagawa (JP); Yutaro MIYAZAKI, Kanagawa (JP); Naoki KASHIWAGURA, Kanagawa (JP); Takao TANIMOTO, Kanagawa (JP)

(21) Appl. No.: 19/024,109

(22) Filed: Jan. 16, 2025

(30) Foreign Application Priority Data
Feb. 8, 2024 (JP) 2024-017843

(51) Int. Cl. H04B 10/079

(52) U.S. Cl. CPC H04B 10/07953

(57) ABSTRACT

An object of the present disclosure is to measure a GOSNR to which a nonlinear noise power is added from signal light. According to the present disclosure, there is provided a GOSNR measurement device including: a calculation processing unit (14) that calculates a total noise power (Pₜₒₜₐₗ₋ₙₒᵢₛₑ), which is a sum of a nonlinear noise power (Pₙₗ) and an ASE noise power (Pₐₛₑ) in an optical fiber transmission line (93), by using Stokes parameters obtained by causing signal light to propagate through the optical fiber transmission line, and measures a generalized optical signal to noise ratio (GOSNR) by using the total noise power.

### TECHNICAL FIELD

The present disclosure relates to a GOSNR measurement device and a GOSNR measurement method for an optical fiber.

### BACKGROUND ART

In a case where high-power light is propagated through an optical fiber, nonlinear polarization occurs in glass, and various nonlinear optical phenomena occur. For example, in an optical fiber, a refractive index of the optical fiber changes in proportion to an optical power of incident light due to an optical Kerr effect. Therefore, self-phase modulation (SPM) and cross-phase modulation (XPM) occur. The SPM is a phenomenon in which the refractive index changes due to an optical Kerr effect caused by the optical signal power itself and thus phase modulation is caused. The XPM is a phenomenon in which the refractive index changes due to an optical Kerr effect caused by the optical power of another optical signal and thus phase modulation is caused. In addition, main nonlinear optical phenomena occurring in an optical fiber include four-wave mixing (FWM) in which, in a case where signal light beams having two or more wavelengths are input, a light beam having a new wavelength is generated between the signal light beams.

In a case where such a nonlinear optical phenomenon occurs in an optical fiber, waveform degradation due to loss of linearity in the optical response, a crosstalk deterioration due to generation of a wavelength other than the wavelengths of the incident light beams, and the like occur. These nonlinear noises deteriorate a quality of a signal propagating through the optical fiber. Therefore, it is required to measure a generalized optical signal to noise ratio (GOSNR) after a signal propagates through an optical fiber, by using a total noise obtained by adding a nonlinear noise to an amplified spontaneous emission (ASE) noise.

The GOSNR can be represented by the following equation in consideration of OSNR_{ASE} due to an ASE noise and OSNR_{NL} due to a nonlinear noise.

$$\begin{matrix}1 / GOSNR = 1 / {OSNR}_{ASE} + 1 / {OSNR}_{NL} \\ = ( ASE noise power + nonlinear noise power ) / \\ optical signal power\end{matrix}$$

An optical spectrum analyzer that includes a Stokes parameter measurement unit and can measure an optical spectrum and a polarized state of signal light has been proposed (for example, refer to Patent Document 1). However, in Patent Document 1, although an ASE noise power can be measured from the signal light, a GOSNR to which a nonlinear noise power is added cannot be measured.

### RELATED ART DOCUMENT

### [Patent Document]

[Patent Document 1] JP-A-2010-002190

### DISCLOSURE OF THE INVENTION

### Problem that the Invention is to Solve

An object of the present disclosure is to measure a GOSNR to which a nonlinear noise power is added from signal light.

### Means for Solving the Problem

Nonlinear polarization is represented by a sum of terms proportional to the square and the cube of the electric field of incident light. A coefficient of a second-order nonlinear optical term is referred to as a second-order nonlinear optical susceptibility, and a coefficient of a third-order nonlinear optical term is referred to as a third-order nonlinear optical susceptibility. A nonlinear optical phenomenon of an optical fiber is mainly caused by a third-order nonlinear optical susceptibility since the optical fiber has a point-symmetric structure with a central axis of a core as a center. Therefore, in the present disclosure, a nonlinear noise power is measured by using a third-order nonlinear optical term.

According to the present disclosure, there is provided a GOSNR measurement device including: a calculation processing unit (14) that calculates a total noise power (Pₜₒₜₐₗ₋ₙₒᵢₛₑ), which is a sum of a nonlinear noise power (Pₙₗ) and an ASE noise power (Pₐₛₑ) in an optical fiber transmission line (93), by using Stokes parameters obtained by causing signal light to propagate through the optical fiber transmission line, and measures a generalized optical signal to noise ratio (GOSNR) by using the total noise power.

The calculation processing unit may calculate, based on a third-order nonlinear optical term for an optical signal power (P_{sig}) that is input to the optical fiber transmission line, the nonlinear noise power (Pₙₗ) by applying, to the third-order nonlinear optical term, a coefficient (k_{PL}) of polarized components and a coefficient (k_{NPL}) of non-polarized components, the coefficients corresponding to the nonlinear noise power (Pₙₗ) in the optical fiber transmission line.

The calculation processing unit may calculate a non-polarized noise power (P_{NPLnoise}) by using the Stokes parameters, calculate a polarized noise power (P_{PLnoise}) by using the k_{PL} and the P_{sig}, and obtain the total noise power (Pₜₒₜₐₗ₋ₙₒᵢₛₑ) by adding the non-polarized noise power and the polarized noise power.

The calculation processing unit may calculate a first measurement power Pₜₒₜₐₗ(L₁) and a first non-polarized noise power P_{NPLnoise}(L₁) by using Stokes parameters obtained by causing first signal light to propagate through the optical fiber transmission line, and calculates a second measurement power Pₜₒₜₐₗ(L₂) and a second non-polarized noise power P_{NPLnoise}(L₂) by using Stokes parameters obtained by causing second signal light, which has an optical signal power different from an optical signal power of the first signal light, to propagate through the optical fiber transmission line, and calculate an optical signal power P_{sig}(L₁) of the first signal light or an optical signal power P_{sig}(L₂) of the second signal light by using the first measurement power Pₜₒₜₐₗ(L₁), the first non-polarized noise power P_{NPLnoise}(L₁), the second measurement power Pₜₒₜₐₗ(L₂), and the second non-polarized noise power P_{NPLnoise}(L₂).

For example, a ratio α between the optical signal powers of the first signal light and the second signal light may be known, and the calculation processing unit may calculate the optical signal power P_{sig}(L₁) of the first signal light by using Equation (16) to be described.

According to the present disclosure, there is provided a GOSNR measurement method including: a first measurement procedure of measuring first Stokes parameters by causing first signal light to propagate through an optical fiber transmission line (93); and a second measurement procedure of measuring second Stokes parameters by causing second signal light, which has an optical signal power different from an optical signal power of the first signal light, to propagate through the optical fiber transmission line, in which a calculation processing unit (14) calculates a total noise power (Pₜₒₜₐₗ₋ₙₒᵢₛₑ), which is a sum of a nonlinear noise power (Pₙₗ) and an ASE noise power (Pₐₛₑ) in the optical fiber transmission line, by using the first Stokes parameters and the second Stokes parameters, and calculates a generalized optical signal to noise ratio (GOSNR) by using the total noise power.

The above disclosures can be combined as much as possible.

### Advantage of the Invention

According to the present disclosure, it is possible to measure a GOSNR to which a nonlinear noise power is added from signal light.

### BRIEF DESCRIPTION OF THE DRAWINGS

FIG. 1 illustrates a configuration example of a GOSNR measurement device according to the present disclosure.

FIG. 2 illustrates a configuration example of a GOSNR measurement method according to the present disclosure.

### BEST MODE FOR CARRYING OUT THE INVENTION

Hereinafter, an embodiment of the present disclosure will be described in detail with reference to the drawings. The present disclosure is not limited to the embodiment described below. These implementation examples are merely illustrative, and the present disclosure can be implemented in various modified and improved forms based on the knowledge of those skilled in the art. It is assumed that, in the present specification and the drawings, components having the same reference numerals are the same as each other.

### First Embodiment

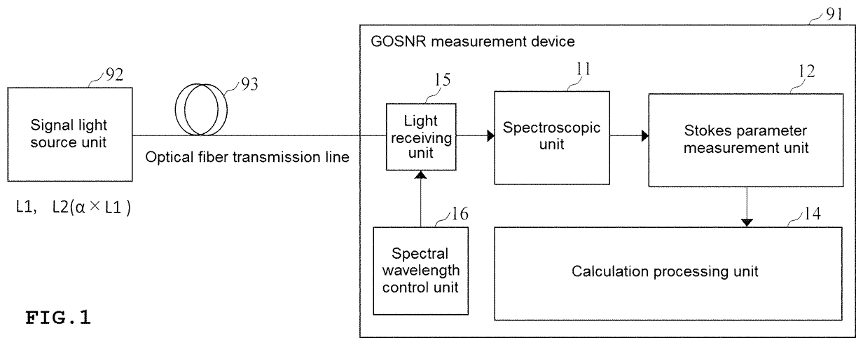

FIG. 1 illustrates a system configuration example according to the present disclosure. The system according to the present disclosure executes a GOSNR measurement method according to the present disclosure. Specifically, in a case where signal light is input from a signal light source unit 92 to an optical fiber transmission line 93, the signal light propagates through the optical fiber transmission line 93, and then polarization characteristics of the signal light are measured by a GOSNR measurement device 91. The signal light source unit 92 sequentially outputs two or more signal light beams with a known optical signal power ratio to the optical fiber transmission line 93. The signal light is, for example, WDM signal light.

The GOSNR measurement device 91 according to the present embodiment includes a spectroscopic unit 11, a Stokes parameter measurement unit 12, a calculation processing unit 14, a light receiving unit 15, and a spectral wavelength control unit 16. The light receiving unit 15 receives the signal light propagating through the optical fiber transmission line 93. The spectroscopic unit 11 spectroscopically splits the signal light that is input from the light receiving unit 15 according to wavelengths. Thereby, light beams having certain wavelength components are extracted by the spectroscopic unit 11. In the present disclosure, the spectral wavelength control unit 16 that sweeps and controls the wavelengths which are spectroscopically split by the spectroscopic unit 11 may be included.

The Stokes parameter measurement unit 12 measures each of polarized components required for measuring Stokes parameters (S₀, S₁, S₂, and S₃), for each of the wavelengths that are spectroscopically split by the spectroscopic unit 11. Various forms for the polarized components can be adopted. In the present embodiment, an example of measuring an optical power I₀ of a linearly-polarized component at 0 degree, an optical power I₉₀ of a linearly-polarized component at 90 degrees, an optical power I₄₅ of a linearly-polarized component at 45 degrees, and an optical power I_{q45} of a circularly-polarized component will be described.

The calculation processing unit 14 calculates Stokes parameters by using each of the polarized components obtained by the Stokes parameter measurement unit 12. For example, the calculation processing unit 14 calculates Stokes parameters (S₀, S₁, S₂, and S₃) by using the following equation.

$${S}_{0} = {I}_{0} + {I}_{90} \qquad ( 1 )$$

$${S}_{1} = 2 \times {I}_{0} - {S}_{0} \qquad ( 2 )$$

$${S}_{2} = 2 \times {I}_{45} - {S}_{0} \qquad ( 3 )$$

$${S}_{3} = 2 \times {I}_{q 45} - {S}_{0} \qquad ( 4 )$$

Here, S₀ indicates a total optical power, S₁ indicates an optical power difference between x polarization and y polarization, S₂ indicates an optical power difference between 45-degree polarization and 135-degree polarization, and S₃ indicates an optical power difference between right-handed circular polarization and left-handed circular polarization. The completely-polarized light is displayed as a polarized state on a Poincare sphere with S₁, S₂, and S₃ as coordinate axes.

Assuming that the optical signal power is P_{sig}, the nonlinear noise power is Pₙₗ, and the ASE noise power is Pₐₛₑ, a measurement power (Pₜₒₜₐₗ=S₀) obtained from the Stokes parameters is represented by the following equation.

$${P}_{total} = {P}_{sig} + {P}_{n 1} + {P}_{ase} \qquad ( 5 )$$

In a case of a glass medium, atomic arrangement in the glass is random and effectively isotropic, and there is no second-order nonlinear optical term. Therefore, in a case where an optical fiber made of a glass medium is used for the optical fiber transmission line 93, the nonlinear noise power Pₙₗ in the optical fiber transmission line 93 can be represented by a third-order nonlinear optical term as in the following equation.

$${P}_{n 1} = k \cdot {P}_{sig}^{3} \qquad ( 6 )$$

Here, k is a proportionality constant.

In a case where the proportionality k is represented by a sum of a proportionality coefficient (k_{PL}) of a nonlinear noise power of polarized components and a proportionality coefficient (k_{NPL}) of a nonlinear noise power of non-polarized components, the proportionality k can be represented by the following equation.

$${P}_{n 1} = ( {k}_{PL} + {k}_{NPL} ) \cdot {P}_{sig}^{3} \qquad ( 7 )$$

In addition, from Equation (5) and Equation (7), the following equation is obtained.

$$\begin{matrix}{P}_{total} = {P}_{sig} + ( {k}_{PL} + {k}_{NPL} ) \cdot {P}_{sig}^{3} + {P}_{ase} \\ = {P}_{sig} + {k}_{PL} \cdot {P}_{sig}^{3} + ( {k}_{NPL} \cdot {P}_{sig}^{3} + {P}_{ase} ) \\ = {P}_{sig} + {k}_{PL} \cdot {P}_{sig}^{3} + {P}_{NPLnoise}\end{matrix} \qquad ( 8 )$$

In Equation (8), a first term indicates an optical signal power, a second term indicates a nonlinear noise power of the polarized components, and a third term indicates a non-polarized noise power. Here, the non-polarized noise power P_{NPLnoise} indicates a noise power of non-polarized components that includes a nonlinear noise power k_{NPL}·P_{sig}³ of non-polarized components and an ASE noise power Pₐₛₑ.

In addition, the non-polarized noise power P_{NPLnoise} can be represented by the following equation using the Stokes parameters (S₀, S₁, S₂, and S₃).

$${P}_{NPLnoise} = {S}_{0} - \sqrt{{S}_{1}^{2} + {S}_{2}^{2} + {S}_{3}^{2}} \qquad ( 9 )$$

In the present disclosure, a plurality of signal light beams having different optical signal powers are input from the signal light source unit 92 to the optical fiber transmission line 93 at different timings, the Stokes parameters (S₀, S₁, S₂, and S₃) are measured in the GOSNR measurement device 91, and the measurement power Pₜₒₜₐₗ and the non-polarized noise power P_{NPLnoise} are calculated. In the present embodiment, an example in which two signal light beams having optical signal powers P_{sig}(L₁) and P_{sig}(L₂) are input from the signal light source unit 92 to the optical fiber transmission line 93 at different timings will be described.

In a case where the optical signal powers are P_{sig}(L₁) and P_{sig}(L₂), Equation (8) can be represented as in Equation (10) and Equation (11).

$${P}_{total} ( {L}_{1} ) = {P}_{sig} ( {L}_{1} ) + {k}_{PL} \cdot {{P}_{Psig} ( {L}_{1} )}^{3} + {P}_{NPLnoise} ( {L}_{1} ) \qquad ( 10 )$$

$${P}_{total} ( {L}_{2} ) = {P}_{sig} ( {L}_{2} ) + {k}_{PL} \cdot {{P}_{sig} ( {L}_{2} )}^{3} + {P}_{NPLnoise} ( {L}_{2} ) \qquad ( 11 )$$

In the present embodiment, the following equation is satisfied between the optical signal powers P_{sig}(L₁) and P_{sig} (L₂).

$${P}_{sig} ( {L}_{2} ) = α \times {P}_{sig} ( {L}_{1} )$$

Therefore, from Equation (10) and Equation (11), Equation (12) and Equation (13) are obtained.

$${P}_{total} ( {L}_{1} ) = {P}_{sig} ( {L}_{1} ) + {k}_{PL} \cdot {{P}_{sig} ( {L}_{1} )}^{3} + {P}_{NPLnoise} ( {L}_{1} ) \qquad ( 12 )$$

$${P}_{total} ( {L}_{2} ) = α \cdot {P}_{sig} ( {L}_{1} ) + {k}_{PL} \cdot {α}^{3} \cdot {{P}_{sig} ( {L}_{1} )}^{3} + {P}_{NPLnoise} ( {L}_{2} ) \qquad ( 13 )$$

From Equation (12), the following equation is obtained.

$${k}_{PL} \cdot {{P}_{sig} ( {L}_{1} )}^{3} = {P}_{total} ( {L}_{1} ) - {P}_{NPLnoise} ( {L}_{1} ) - {P}_{sig} ( {L}_{1} ) \qquad ( 14 )$$

In a case where Equation (14) is substituted into Equation (13), Equation (15) is obtained, and Equation (16) is obtained.

$${P}_{total} ( {L}_{2} ) - {P}_{NPLnoise} ( {L}_{2} ) = α \cdot {P}_{sig} ( {L}_{1} ) + {α}^{3} \cdot \{ {P}_{total} ( {L}_{1} ) - {P}_{NPLnoise} ( {L}_{1} ) - {P}_{sig} ( {L}_{1} ) \} \qquad ( 15 )$$

$${P}_{sig} ( {L}_{1} ) = \frac{{P}_{total} ( {L}_{2} ) - {P}_{NPLnoise} ( {L}_{2} ) - {α}^{3} \{ {P}_{total} ( {L}_{1} ) - {P}_{NPLnoise} ( {L}_{1} ) \}}{α - {α}^{3}} \qquad ( 16 )$$

Pₜₒₜₐₗ is the total optical power S₀ represented by Equation (1). Therefore, Pₜₒₜₐₗ(L₂) can be calculated by using I₀ and I₉₀ measured in a case where the signal light having the optical signal power P_{sig}(L₂) is propagated through the optical fiber transmission line 93. In addition, Pₜₒₜₐₗ(L₁) can also be calculated by using I₀ and I₉₀ measured in a case where the signal light having the optical signal power P_{sig}(L₁) is propagated through the optical fiber transmission line 93.

In a case where the obtained P_{sig}(L₁) is substituted into Equation (12), k_{PL} (proportionality constant), which is a ratio of the nonlinear noise power of the generated polarized components to the optical signal power, can be specified. For example, the calculation processing unit 14 calculates k_{PL} (proportionality constant) by using the following equation.

$${k}_{PL} = \{ {P}_{total} ( {L}_{1} ) - {P}_{NPLnoise} ( {L}_{1} ) - {P}_{sig} ( {L}_{1} ) \} / {{P}_{sig} ( {L}_{1} )}^{3} \qquad ( 17 )$$

In addition, the calculation processing unit 14 can obtain a polarized noise power P_{PLnoise}(L₁), which is a nonlinear noise power of the polarized components, by using Equation (18).

$${P}_{PLnoise} ( {L}_{1} ) = {k}_{PL} \cdot {{P}_{sig} ( {L}_{1} )}^{3} \qquad ( 18 )$$

Further, a total noise power Pₜₒₜₐₗ₋ₙₒᵢₛₑ(L₁), which is a sum of the nonlinear noise power Pₙₗ(L₁) and the ASE noise power Pₐₛₑ(L₁), can be obtained by adding the polarized noise power P_{PLnoise}(L₁) and the non-polarized noise power P_{NPLnoise}(L₁).

$${P}_{total - noise} ( {L}_{1} ) = {P}_{n 1} ( {L}_{1} ) + {P}_{ase} ( {L}_{1} ) = {P}_{PLnoise} ( {L}_{1} ) + {P}_{NPLnoise} ( {L}_{1} ) \qquad ( 19 )$$

The GOSNR can be obtained from the optical signal power P_{sig}(L₁) and the total noise power Pₜₒₜₐₗ₋ₙₒᵢₛₑ(L₁) by using Equation (20).

$$GOSNR ( {L}_{1} ) = 10 \cdot {LOG}_{10} \{ {P}_{sig} ( {L}_{1} ) / {P}_{total - noise} ( {L}_{1} ) \} + 10 \cdot {LOG}_{10} ( {B}_{m} / {B}_{ref} ) \qquad ( 20 )$$

Here, Bₘ indicates a measurement light bandwidth, and B_{ref} indicates a reference light bandwidth (typically, 0.1 nm)

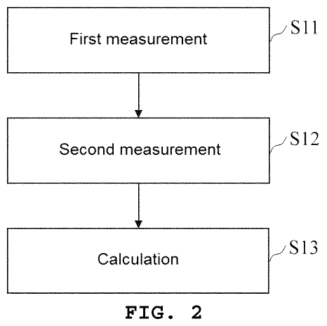

FIG. 2 illustrates an example of a GOSNR measurement method according to the present disclosure. The GOSNR measurement method according to the present disclosure includes a first measurement procedure S11, a second measurement procedure S12, and a calculation procedure S13.

In the first measurement procedure S11, first signal light is propagated through the optical fiber transmission line 93, and first Stokes parameters are measured. Thereby, the calculation processing unit 14 can calculate Pₜₒₜₐₗ(L₁) and P_{NPLnoise}(L₁) by using Equation (1) to Equation (4), and Equation (9).

In the second measurement procedure S12, second signal light is propagated through the optical fiber transmission line 93, and second Stokes parameters are measured. Thereby, the calculation processing unit 14 can calculate Pₜₒₜₐₗ(L₂) and P_{NPLnoise}(L₂) by using Equation (1) to Equation (4), and Equation (9).

In the calculation procedure S13, the calculation processing unit 14 can calculate a polarized noise power P_{PLnoise}(L₁) of the first signal light by using Equation (17) and Equation (18).

In this way, by inputting the signal light of which the ratio α between the optical signal powers is known and detecting each of the Stokes parameters, it is possible to obtain the optical signal power P_{sig}(L₁), the polarized noise power P_{PLnoise}(L₁) which is the nonlinear noise power of the polarized components, and the non-polarized noise power P_{NPLnoise}(L₁) which includes the nonlinear noise power of the non-polarized components and the ASE noise power. In the present embodiment, an example in which the polarized noise power P_{PLnoise}(L₁) and the non-polarized noise power P_{NPLnoise}(L₁) are obtained has been described. On the other hand, the polarized noise power P_{PLnoise}(L₂) and the non-polarized noise power P_{NPLnoise}(L₂) may be obtained. The same applies to the following embodiments.

### Second Embodiment

The present method can also be applied to a case where a second-order nonlinear optical term and a third-order nonlinear optical term are included. For example, the measurement power Pₜₒₜₐₗ=S₀ obtained from the Stokes parameters can be obtained by using the following equation.

$${P}_{total} = {P}_{sig} + {P}_{n 1} + {P}_{ase} \qquad ( 21 )$$

Here, P_{sig} is the optical signal power, Pₙₗ is the nonlinear noise power, and Pₐₛₑ is the ASE noise power.

The nonlinear noise power Pₙₗ can be obtained by using the following equation.

$${P}_{n 1} = {k}_{2} \cdot {{P}_{sig}}^{2} + {k}_{3} \cdot {{P}_{sig}}^{3} \qquad ( 22 )$$

Here, k₂ is a proportionality constant of the second-order nonlinear optical term, and k₃ is a proportionality constant of the third-order nonlinear optical term.

In a case where the proportionality k₂ and the proportionality k₃ are represented by a sum of a proportionality coefficient (k_{PL2} and k_{PL3}) of the nonlinear noise power of the polarized components and a proportionality coefficient (k_{NPL2} and k_{NPL3}) of the nonlinear noise power of the non-polarized components, Equation (22) is represented by Equation (23).

$${P}_{n 1} = ( {k}_{PL 2} + {k}_{NPL 2} ) \cdot {{P}_{sig}}^{2} + ( {k}_{PL 3} + {k}_{NPL 3} ) \cdot {{P}_{sig}}^{3} \qquad ( 23 )$$

Here, k_{PL2} is a proportionality coefficient of the second-order nonlinear noise of the polarized components, k_{NPL2} is a proportionality coefficient of the second-order nonlinear noise of the non-polarized components, k_{PL3} is a proportionality coefficient of the third-order nonlinear noise of the polarized components, and k_{NPL3} is a proportionality coefficient of the third-order nonlinear noise of the non-polarized components.

Therefore, Equation (21) can be represented by Equation (24).

$${P}_{total} = {P}_{sig} + ( {k}_{PL 2} + {k}_{NPL 2} ) \cdot {{P}_{sig}}^{2} + ( {k}_{PL 3} + {k}_{NPL 3} ) \cdot {{P}_{sig}}^{3} + {P}_{ase} = {P}_{sig} + ( {k}_{PL 2} \cdot {{P}_{sig}}^{2} + {k}_{PL 3} \cdot {{P}_{sig}}^{3} ) + ( {k}_{NPL 2} \cdot {{P}_{sig}}^{2} + {k}_{NPL 3} \cdot {{P}_{sig}}^{3} + {P}_{ase} ) \qquad ( 24 )$$

In Equation (24), the first term indicates the optical signal power, the second term indicates the nonlinear noise power of the polarized components, and the third term indicates the non-polarized noise power (P_{NPLnoise}=k_{NPL2}·P_{sig}²+k_{NPL3}·P_{sig}³+Pₐₛₑ) including the nonlinear noise power of the non-polarized components and the ASE noise power.

In the present embodiment, three signal light beams of which the ratios (α and β) between the optical signal powers are known are used. The three signal light beams P_{sig}(L₁), P_{sig}(L₂), and P_{sig}(L₃) are represented by the following equations.

$$\begin{matrix}{P}_{sig} ( {L}_{1} ) \\ {P}_{sig} ( {L}_{2} ) = α \times {P}_{sig} ( {L}_{1} ) \\ {P}_{sig} ( {L}_{3} ) = β \times {P}_{sig} ( {L}_{1} )\end{matrix}$$

From the above relationship, the following equation is satisfied.

$${P}_{total} ( {L}_{1} ) = {P}_{sig} ( {L}_{1} ) + {k}_{PL 2} \cdot {{P}_{sig} ( {L}_{1} )}^{2} + {k}_{PL 3} \cdot {{P}_{sig} ( {L}_{1} )}^{3} + {P}_{NPLnoise} ( {L}_{1} ) \qquad ( 25 )$$

$${P}_{total} ( {L}_{2} ) = {P}_{sig} ( {L}_{2} ) + {k}_{PL 2} \cdot {{P}_{sig} ( {L}_{2} )}^{2} + {k}_{PL 3} \cdot {{P}_{sig} ( {L}_{2} )}^{3} + {P}_{NPLnoise} ( {L}_{2} ) = {P}_{sig} ( {L}_{1} ) + {k}_{PL 2} \cdot {α}^{2} \cdot {{P}_{sig} ( {L}_{1} )}^{2} + {k}_{PL 3} \cdot {α}^{3} \cdot {{P}_{sig} ( {L}_{1} )}^{3} + {P}_{NPLnoise} ( {L}_{2} ) \qquad ( 26 )$$

$${P}_{total} ( {L}_{3} ) = {P}_{sig} ( {L}_{3} ) + {k}_{PL 2} \cdot {{P}_{sig} ( {L}_{3} )}^{2} + {k}_{PL 3} \cdot {{P}_{sig} ( {L}_{3} )}^{3} + {P}_{NPLnoise} ( {L}_{3} ) = {P}_{sig} ( {L}_{1} ) + {k}_{PL 2} \cdot {β}^{2} \cdot {{P}_{sig} ( {L}_{1} )}^{2} + {k}_{PL 3} \cdot {β}^{3} \cdot {{P}_{sig} ( {L}_{1} )}^{3} + {P}_{NPLnoise} ( {L}_{2} ) \qquad ( 27 )$$

Pₜₒₜₐₗ(L₃), P_{NPLnoise}(L₃), Pₜₒₜₐₗ(L₂), P_{NPLnoise}(L₂), Pₜₒₜₐₗ(L₁), and P_{NPLnoise}(L₁) are determined from the Stokes parameters. In addition, since α and β are known values, P_{sig}(L₁), k_{PL2}, and k_{PL3} can be obtained from Equation (25), Equation (26), and Equation (27). Therefore, the calculation processing unit 14 can obtain the nonlinear noise power P_{PLnoise}(L₁) of the polarized components by using Equation (28).

$${P}_{PLnoise} ( {L}_{1} ) = {k}_{PL 2} \cdot {{P}_{sig} ( {L}_{1} )}^{2} + {k}_{PL 3} \cdot {{P}_{sig} ( {L}_{1} )}^{3} \qquad ( 28 )$$

Further, a total noise power Pₜₒₜₐₗ₋ₙₒᵢₛₑ(L₁), which is a sum of the nonlinear noise power Pₙₗ(L₁) and the ASE noise power Pₐₛₑ(L₁), can be obtained by adding the polarized noise power P_{PLnoise}(L₁) and the non-polarized noise power P_{NPLnoise}(L₁)

$${P}_{total - noise} ( {L}_{1} ) = {P}_{n 1} ( {L}_{1} ) + {P}_{ase} ( {L}_{1} ) = {P}_{PLnoise} ( {L}_{1} ) + {P}_{NPLnoise} ( {L}_{1} ) \qquad ( 29 )$$

The GOSNR can be obtained from the optical signal power P_{sig}(L₁) and the total noise power Pₜₒₜₐₗ₋ₙₒᵢₛₑ(L₁) by using Equation (30).

$$GOSNR ( {L}_{1} ) = 10 \cdot {LOG}_{10} \{ {P}_{sig} ( {L}_{1} ) / {P}_{total - noise} ( {L}_{1} ) \} + 10 \cdot {LOG}_{10} ( {B}_{m} / {B}_{ref} ) \qquad ( 30 )$$

Here, Bₘ indicates a measurement optical bandwidth, and B_{ref} indicates a reference optical bandwidth (typically, 0.1 nm)

### Other Embodiments

The GOSNR measurement device according to the present invention can also be realized by a computer and a program, and the program can be recorded on a recording medium or provided through a network.

### DESCRIPTION OF REFERENCE NUMERALS AND SIGNS

11: Spectroscopic unit
12: Stokes parameter measurement unit
14: Calculation processing unit
15: Light receiving unit
16: Spectral wavelength control unit
91: GOSNR measurement device
92: Signal light source unit
93: Optical fiber transmission line

What is claimed is:

1. A GOSNR measurement device comprising:
a calculation processing unit that calculates a total noise power (Pₜₒₜₐₗ₋ₙₒᵢₛₑ), which is a sum of a nonlinear noise power (Pₙₗ) and an ASE noise power (Pₐₛₑ) in an optical fiber transmission line, by using Stokes parameters obtained by causing signal light to propagate through the optical fiber transmission line, and measures a generalized optical signal to noise ratio (GOSNR) by using the total noise power.

2. The GOSNR measurement device according to claim 1,
wherein the calculation processing unit calculates,
based on a third-order nonlinear optical term for an optical signal power (P_{sig}) that is input to the optical fiber transmission line,
the nonlinear noise power (Pₙₗ) by applying, to the third-order nonlinear optical term, a coefficient (k_{PL}) of polarized components and a coefficient (k_{NPL}) of non-polarized components, the coefficients corresponding to the nonlinear noise power (Pₙₗ) in the optical fiber transmission line.

3. The GOSNR measurement device according to claim 2,
wherein the calculation processing unit
calculates a non-polarized noise power (P_{NPLnoise}) by using the Stokes parameters,
calculates a polarized noise power (P_{PLnoise}) by using the k_{PL} and the P_{sig}, and
obtains the total noise power (Pₜₒₜₐₗ₋ₙₒᵢₛₑ) by adding the non-polarized noise power and the polarized noise power.

4. The GOSNR measurement device according to claim 2,
wherein the calculation processing unit
calculates a first measurement power Pₜₒₜₐₗ(L₁) and a first non-polarized noise power P_{NPLnoise}(L₁) by using Stokes parameters obtained by causing first signal light to propagate through the optical fiber transmission line, and calculates a second measurement power Pₜₒₜₐₗ(L₂) and a second non-polarized noise power P_{NPLnoise}(L₂) by using Stokes parameters obtained by causing second signal light, which has an optical signal power different from an optical signal power of the first signal light, to propagate through the optical fiber transmission line, and calculates an optical signal power P_{sig}(L₁) of the first signal light or an optical signal power P_{sig}(L₂) of the second signal light by using the first measurement power Pₜₒₜₐₗ(L₁), the first non-polarized noise power P_{NPLnoise}(L₁), the second measurement power Pₜₒₜₐₗ(L₂), and the second non-polarized noise power P_{NPLnoise}(L₂).

5. The GOSNR measurement device according to claim 4,
wherein a ratio α between the optical signal powers of the first signal light and the second signal light is known, and
the calculation processing unit calculates the optical signal power P_{sig}(L₁) of the first signal light by using the following equation:
$${P}_{sig} ( {L}_{1} ) = \frac{{P}_{total} ( {L}_{2} ) - {P}_{NPLnoise} ( {L}_{2} ) - {α}^{3} \{ {P}_{total} ( {L}_{1} ) - {P}_{NPLnoise} ( {L}_{1} ) \}}{α - {α}^{3}} .$$

6. A GOSNR measurement method comprising:
a first measurement procedure of measuring first Stokes parameters by causing first signal light to propagate through an optical fiber transmission line; and a second measurement procedure of measuring second Stokes parameters by causing second signal light, which has an optical signal power different from an optical signal power of the first signal light, to propagate through the optical fiber transmission line,
wherein a calculation processing unit calculates a total noise power (Pₜₒₜₐₗ₋ₙₒᵢₛₑ), which is a sum of a nonlinear noise power (Pₙₗ) and an ASE noise power (Pₐₛₑ) in the optical fiber transmission line, by using the first Stokes parameters and the second Stokes parameters, and calculates a generalized optical signal to noise ratio (GOSNR) by using the total noise power.
